(19) United States
(12) Patent Application Publication
(10) Pub. No.: US 2013/0120293 A1
(43) Pub. Date: May 16, 2013

(54) TOUCHSCREEN-ENABLED TERMINAL AND APPLICATION CONTROL METHOD THEREOF

(71) Applicant: Samsung Electronics Co., Ltd., Gyeonggi-do (KR)

(72) Inventor: Hayoung JEON, Seoul (KR)

(73) Assignee: SAMSUNG ELECTRONICS CO., LTD., Gyeonggi-do (KR)

(21) Appl. No.: 13/676,224

(22) Filed: Nov. 14, 2012

(30) Foreign Application Priority Data
Nov. 14, 2011 (KR) 10-2011-0118037

(51) Int. Cl. G06F 3/01

(52) U.S. Cl. CPC G06F 3/01
USPC 345/173

(57) ABSTRACT

A touchscreen-enabled terminal and application control method thereof is provided for facilitating control of the currently running application by presenting function keys mapped to the touch regions on the screen in response of multi-touch detected on the touchscreen. The application control apparatus of the present invention includes a touchscreen including a display panel for displaying an application execution screen and a touch panel for receiving user input for controlling the application; and a control unit which controls, when a multi-touch event with at least three touch regions is detected, the touchscreen to display function keys mapped to the touch regions. The touchscreen-enabled terminal and application control method thereof according to the present invention facilitates user's manipulation of functions of an application.

### CLAIM OF PRIORITY

This application claims the benefit under 35 U.S.C. §119(a) of a Korean patent application filed on Nov. 14, 2011 in the Korean Intellectual Property Office and assigned Serial No. 10-2011-0118037, the entire disclosure of which is hereby incorporated by reference.

### BACKGROUND OF THE INVENTION

1. Field of the Invention

The present invention relates to a touchscreen-enabled terminal and application control method thereof and, in particular, to a terminal equipped with a touchscreen and a method for facilitating control of the currently running application by presenting function keys mapped to the touch regions on the screen in response to a multi-touch gesture detected on the touchscreen.

2. Description of the Related Art

Physically, electronic devices are provided with various input devices. In order to provide mobile intuitive input mechanism, the terminal is equipped with a touchscreen in addition to the button-type key input unit. The touchscreen is provided with a display panel for displaying the execution screen of an application and a touch panel for detecting user's contact to generate a touch event. The user can make a contact on the touch panel to interface and to control the application.

Recently, the rapid advance of the semiconductor and information communication technologies has made it possible to integrate diverse functions into an electronic device and download and install various applications. As a result, the electronic device now allows the user to control the functions by means of the touchscreen freely. More recently, there is a trend toward touchscreens of electronic devices growing in size in order to provide the user with rich multimedia experience and improve the user convenience.

In the conventional method for controlling the application with various functions, the user has to enter a separate menu screen though multiple steps to manipulate the application, thus resulting in user inconvenience. In cases where the electronic device is equipped with a large size touchscreen, it requires a relatively large gesture on a predetermined region of the large size touchscreen to execute a specific function of the application which in turn also results in inconvenient utilization of the electronic device.

### SUMMARY OF THE INVENTION

The present invention has been made in an effort to solve the above problems and provides additional advantages, by providing a touchscreen-enabled terminal and application control method thereof for facilitating the manipulation of desired functions in the currently running application.

In accordance with an aspect of the present invention, an application control method includes executing an application; displaying an execution screen of the application; and presenting, when a multi-touch event with at least three touch regions is detected, at least one function key mapped to the respective touch regions.

In accordance with another aspect of the present invention, an application control apparatus includes a touchscreen including a display panel for displaying an application execution screen and a touch panel for receiving user input for controlling the application; and a control unit which controls, when a multi-touch event with at least three touch regions is detected, the touchscreen to display function keys mapped to the touch regions.

### BRIEF DESCRIPTION OF THE DRAWINGS

FIG. 1 is a block diagram illustrating a configuration of the terminal according to an embodiment of the present invention;

FIG. 2 is a block diagram illustrating a configuration of the control unit of FIG. 1;

FIG. 3 is a flowchart illustrating a three finger touch control procedure according to an embodiment of the present invention;

FIGS. 4 to 6 are diagrams illustrating exemplary Text-To-Speech (TTS) application execution screens providing control functions according to an embodiment of the present invention; and

FIGS. 7 and 8 are diagrams illustrating exemplary audio playback application execution screens providing control functions according to another embodiment of the present invention.

### DETAILED DESCRIPTION OF EXEMPLARY EMBODIMENTS

Exemplary embodiments of the present invention are described with reference to the accompanying drawings in detail. The same reference numbers are used through the drawings to refer to the same or like parts. For the purposes of clarity and simplicity, detailed description of well-known functions and structures incorporated herein may be omitted to avoid obscuring the subject matter of the present invention.

In the following description, the term “touch” denotes an action of making a contact on the touch panel with an object. The term “multi-touch” denotes an action of making contact at least two points on the touch panel with at least two objects. Although the description is directed to the three finger touch herein for illustrative purposes, it is obvious to those skilled in the art that the touch can be made at three or more points by means of touch objects.

In the following description, the term “drop” denotes an action of releasing a contact from the touch panel, i.e. lifting off the touch object from the surface of the touch panel. The term “tap” denotes an action of making a touch and then drop with a touch object in sequence on the touch panel. The term “drag” is an action of moving the touch object on the touch panel.

In the following description, the term “split-tap” denotes an action of making a series of combinations of drop (or lift), touch, and drop (or lift) during the multi-touch state. That is, the split-tap is made in such a way that the user makes the tapping action to at one contact point while the fingers are in the state of multi-touch. The “split-tap” is defined as a series of action consisting of the drop, touch, and drop during the multi touch state. The last drop action distinguishes the “split-action” from another series of action consisting of the drop and maintaining touch for executing “quick move to next object to listen”.

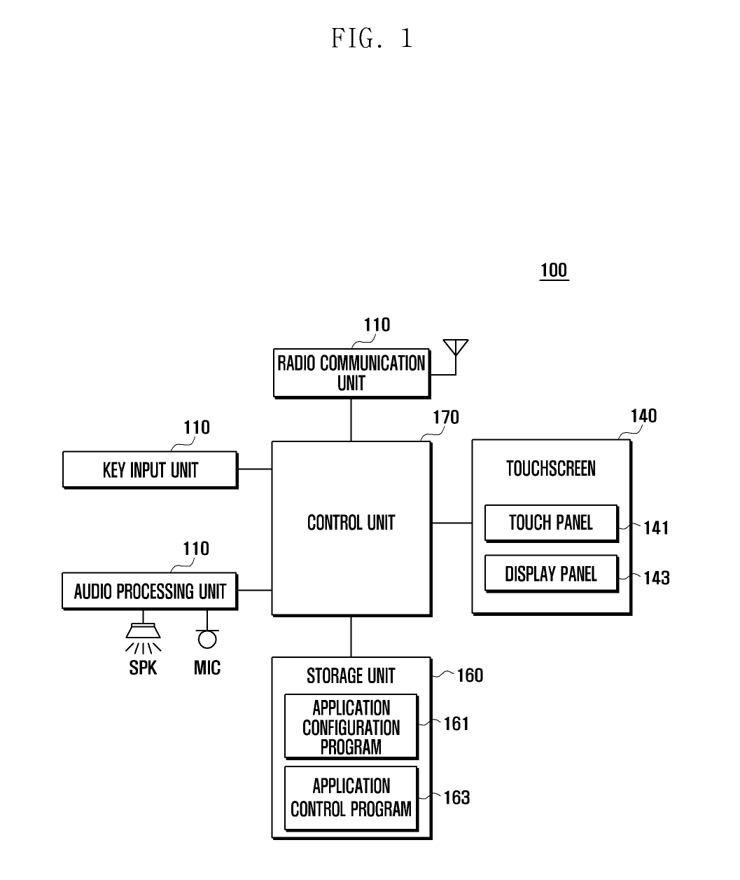

FIG. 1 is a block diagram illustrating a configuration of the terminal according to an embodiment of the present invention. The present invention can be applied to any electronic device equipped with a touchscreen such as mobile phone, smartphone, tablet PC, automotive navigator, television, PDA, monitor, and other consumer electronic devices such as refrigerator, laundry machine, home entertainment system, and alarm system.

As shown, the terminal 100 according to an embodiment of the present invention includes a radio communication unit 110, a key input unit 120, an audio processing unit 130, a touchscreen 140, a storage unit 160, and a control unit 170.

In operation, the radio communication unit 110 is responsible for establishing communication channels for voice, video, and data communications under the control of the control unit 170. Particularly, in an embodiment of the present invention, the radio communication unit 110 is capable of receiving the configuration of functions linked to the touch region in association with the three-finger-touch per the application. The control unit 170 is capable of controlling the application according to the configuration in executing the application control function (hereinafter, three-finger-touch function) with the three finger touch.

The key input unit 120 includes a plurality of alphanumeric keys for receiving alphanumeric inputs and function keys for receiving inputs for configuration of various functions. The function keys may include navigation keys, side keys, and shortcut keys configured for specific functions. The key input unit 120 generates key signals related to the user inputs and terminal function control to the control unit 170. In an embodiment in which the touchscreen 140 of the terminal 100 is implemented in the form of a full touchscreen, the terminal may be provided only with side keys formed at the side of the terminal case. Particularly in an embodiment of the present invention, the key input unit 102 is capable of activating or deactivating the three-finger touch function.

The audio processing unit 130 includes a speaker for outputting the audio signals corresponding to the audio data exchanged in a voice call and attached to a message and generated by playing back an audio file. The audio processing unit 130 further includes a microphone (MIC) for receiving the audio signal including user's voice and other sound. Particularly when a touch event is detected in the state where the three-finger touch function is running, the audio processing unit 130 is capable of outputting the corresponding sound effect. For example, if the three-finger touch event is detected first in the state where an application is running, the audio processing unit 130 is capable of outputting a sound effect alarming the execution of the three-finger touch function and, when a touch event related to the touch region is detected, a sound effect alarming the execution of the corresponding function. The sound effects can be muted according to the user configuration. The audio processing unit 130 is capable of supporting speech recognition function for activating or deactivating the three-finger touch control function in response to the voice signal of the user.

The touchscreen 140 includes a touch panel 141 and a display panel 143. The touchscreen 140 is formed by covering the touch panel 141 over the entire surface of the display panel 143. The size of the touch screen 140 can be determined by the size of the touch panel 141. The touchscreen 140 is capable of displaying application execution screens and detecting the touch event related to the control of applications.

The touch panel 141 is arranged on one of the upper or lower parts of the display panel 143, and the touch sensor as a component of the touch panel 141 is arranged in the form of a matrix. Although not shown, other sensors such as light sensor and vibration sensor, etc. may be implemented in the terminal 100. The touch panel 141 generates a touch event according to the contact or when it senses an object nearby or thereon and sends the touch event to the control unit 170. Here, the touch event includes the information on the type and location of the touch. Particularly in an embodiment of the present invention, the touch panel 141 is capable of generating a touch event for controlling the application based on the three-finger touch. In detail, the touch panel 141 is capable of generating a three-finger touch control function activation event and function execution touch event mapped to specific region. Here, the three-finger touch control function can be provided as a default function.

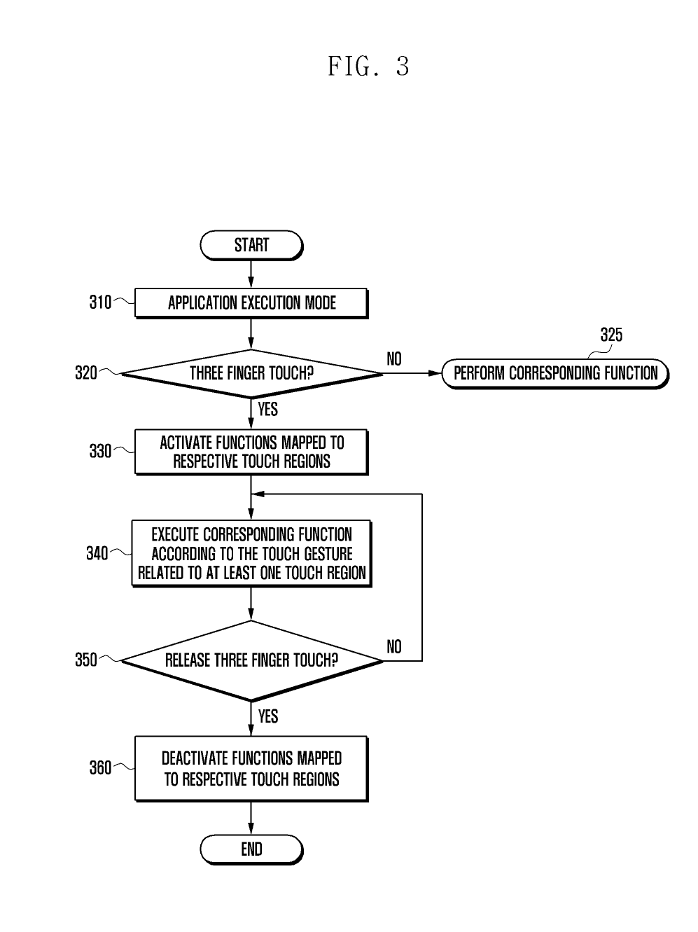

The display panel 143 displays information input by and presented to the user in addition to various menus. That is, the display panel 143 is capable of displaying execution screens of various applications operating on the terminal 100. The display panel 143 can be implemented with a Liquid Crystal Display (LCD) or an Organic Light Emitted Diode (OLED). The display panel 143 can be arranged at the upper or lower parts of the touch panel 141. Particularly in an embodiment of the present invention, the display panel 143 is capable of displaying the activation status or execution status of a function linked to the touch region where the three-finger touch is detected under the control of the control unit 170. The three-finger touch function execution status display method is described in detail later with reference to FIGS. 3-8.

According to an embodiment of the present invention, the storage unit 160 stores at least one application required for functional operations, user data generated by the user, messages exchanged with the network, and the application data generated by the applications. The storage unit 160 is capable of being divided into a program region and a data region.

The program region is capable of storing the Operating System (OS) of the terminal 100 and managing the overall operations of the components of the terminal and applications downloaded and installed. Particularly in an embodiment of the present invention, the program region is capable of further storing an application configuration program 161 and an application control program 163.

The application configuration program 161 includes the routines supporting configuration of the information necessary for supporting the three-finger touch function. The application configuration program 161 is capable of including an application registration routine for registering the three finger touch function-enabled application and a function configuration routine for configuring the functions linked to the respective touch regions.

The function configuration routine is capable of configuring functions in response to the event for selecting at least one of the touch regions with three-finger touch or moving the touch in at least one direction. The function configuration routine is capable of configuring different functions in association with the respective touch regions according to the selection event. For example, the center touch region among the three touch regions corresponding to the three fingers can be configured for toggle-based function selection. For example, it can be configured that the first selection to the center touch region executes the first function, the second selection to the center touch region executes the second function, and the third selection to the center touch region executes the third function. Also, the two side touch regions can be configured to be linked with the functions related to orientation. For example, in case that the side touch regions are being related to navigation function, the left and right touch regions can be configured for upward and downward navigations respectively.

The function configuration routine is also capable of configuring other functions in association with the movement directions in the touch regions of the three-finger touch according to the touch movement event. In addition, the function configuration routine is capable of configuring the functions such that the frequently executed functions of an application are automatically set in association with the respective touch regions.

The application control program 163 includes the routines that are capable of facilitating access to the predetermined functions through the three-finger touch. The application control program 163 is capable of including (1) a three-finger touch detection routine, (2) a touch region-related function activation routine, and (3) a touch region-related function deactivation routine.

(1) The three-finger touch detection routine is configured to detect that the three-finger touch event occurred while an application is running, and the three-finger touch event may not be limited to specific regions of the touch panel 141. Also, the three finger touch detection routine may determine the touch region based on the three finger touch, and the size of the touch region may be adjustable.

(2) The function activation routine is capable of activating at least one function linked to the touch regions. Particularly in an embodiment of the present invention, the function activation routine can be configured such that the function key images corresponding to the respective functions are displayed on the application execution screen.

More specifically, the function execution routine is capable of including a function execution touch event check command generated at the touch region, a function execution command corresponding to the touch region selection event, and a function execution command corresponding to the touch movement event in the touch region, each occurring after the function activation in the respective touch regions. For example, the touch region selection event can be the split-tap made at one of the touch regions, and the touch movement event can be drag-up/down, drag-left/right, or drag in diagonal direction.

(3) The deactivation routine can be configured to detect a drop at the three touch regions. The deactivation routine is capable of removing the function key image on the application execution screen in response to the detection of the drop.

The data region of the storage unit 160 stores the data generated during use of the terminal 100. Particularly in an embodiment of the present invention, the data region stores three finger touch function configuration information used or generated during execution of the application configuration program 161. For example, the data region is capable of storing a list of applications registered for supporting the three finger touch function, a list of functions executed in association with the respective touch regions, function key images to be presented in association with the respective functions, and types of the function execution touch events.

The data region also stores the information to be used or generated in execution of the application control program 163. For example, the data region is capable of storing the data generated by the functions executed in association with the respective touch regions.

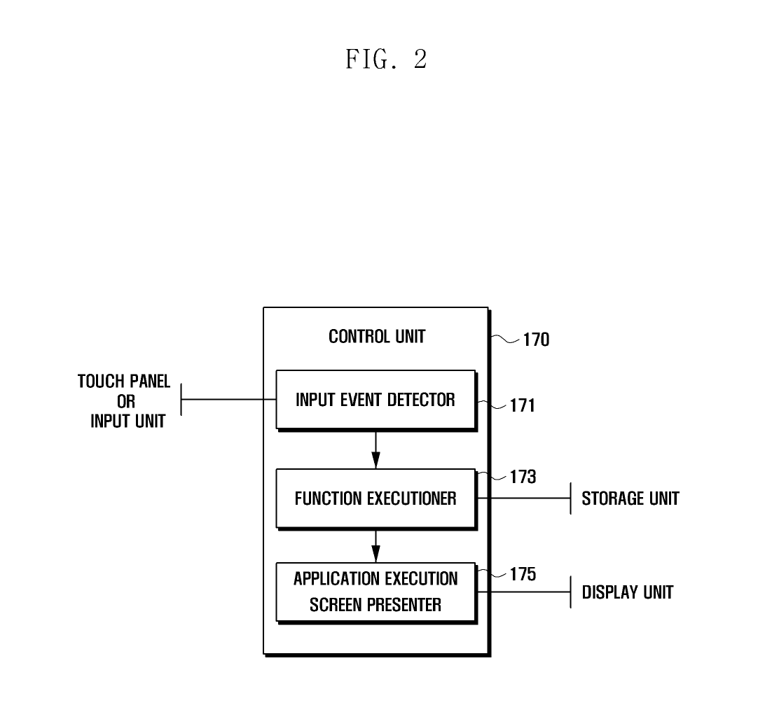

The control unit 170 controls overall operation of the terminal 100. Particularly in an embodiment of the present invention, the control unit 170 is capable of controlling the operations related to the three finger touch control function. For example, the control unit 170 is capable of controlling the display panel 143 to display at least on function key on the execution screen when the three finger touch event is detected during the execution of an application such that the function mapped to the touch region is activated. In order to accomplish this, the control unit 170 can include the components as shown in FIG. 2.

FIG. 2 is a block diagram illustrating a configuration of the control unit of FIG. 1.

As shown in FIG. 2, the control unit 170 includes an input event receiver 171, a function executor 173, and an application execution screen presenter 175.

The input event receiver 171 receives the touch events related to the three finger touch control function from the touch panel 141. Particularly in an embodiment of the present invention, the input event receiver 171 is capable of receiving the three finger touch control function activation event and the touch region-mapped function execution touch event from the touch panel 141. Upon receipt of the function execution touch event, the input event receiver 171 determines whether the received event is a selection event or a touch movement event. The input event receiver 171 delivers the touch event related to the three finger touch control function to the function executor 173.

The input event receiver 171 is capable of receiving the input event related to the three finger touch control function configuration from the key input unit 120 and delivering the input event to the function executor 173. The function executor 173 is capable of configuring the three finger touch control function based on the input events.

The function executor 173 is configured for executing various functions provided by the terminal 100. Particularly in an embodiment of the present invention, the function executor 173 is responsible for analyzing the touch events related to the three finger touch control function received from the input event receiver 171 and executing the corresponding function. More specifically, the function executor 173 checks the positions of the touch regions from the three finger touch control function activation event. The function executor 173 accesses the storage unit 160 to check the function mapped to the respective touch regions and type of the touch, i.e. selection event for executing the function or touch movement event. Upon detecting the predetermined touch event, the function executor 173 executes the function mapped to the touch region.

The application execution screen presenter 175 controls the display panel 143 to display the screen corresponding to the executed application. Particularly in an embodiment of the present invention, the application execution screen presenter 175 is capable of controlling the display panel 143 to display the application execution screen with the indication of three finger touch control function activation or execution status. For example, in order to indicate the activation status of the three finger touch control function, the application execution screen presenter 175 is capable of controlling the display panel 143 to display a controller presenting the functions mapped to the touch regions. The controller can be provided with function keys corresponding to the respective function executable in association with the touch regions. The controller can be displayed as overlaid on the application execution screen or in the form of a popup window. The application execution screen presenter 175 is capable of controlling the display panel 143 to display function keys related to the functions executable for displaying the function execution state on the execution screen.

FIG. 3 is a flowchart illustrating a three finger touch control procedure according to an embodiment of the present invention.

Referring to FIG. 3, in the three finger touch control procedure according to an embodiment of the present invention, the control unit 170 enters the application execution mode at step 310. At this time, the executed application is the application registered to support the three finger touch control function. Here, the control unit 170 controls the display panel 143 to display the execution screen of the application.

Next, the control unit 170 monitors to detect an event and, if an event is detected, determines whether the event is a three finger touch event at step 320. If the three finger touch event is detected at step 320, the control unit 170 activates the three finger touch control function at step 330. Here, the three finger touch event is not limited to specific region of the touch panel 141. If an event is detected but the event is not the three finger touch event, the control unit 170 performs a corresponding function triggered by the event at step 325.

The control unit 170 activates the functions mapped to the touch regions at step 330. Here, the control unit 170 activates the three finger touch function. At this time, the control unit 170 determines the touch regions upon detection of the three finger touch event and checks the functions mapped to the determined touch regions. The control unit 170 controls the display panel 143 to display the function keys corresponding to the checked functions on the execution screen. At this time, the control unit 170 controls the display panel to display a controller having the function keys. Here, the controller is capable of including the function keys displayed at the respective touch regions.

The control unit 170 checks the function execution touch events triggering the execution of the checked functions. Accordingly, when a function execution touch event is made on at least one touch region, the control unit 170 activates the functions mapped to the respective touch regions. The control unit 170 is also capable of controlling the display panel 143 to display the information about the activated function, e.g. text notifying of the function name or execution method.

The control unit 170 executes the function corresponding to the touch gesture associated with the at least one touch region at step 340. Here, the control unit 170 is capable of checking the touch gesture made at the at least one touch region. That is, the control unit 170 is capable of analyzing the touch event sensed by the touch panel to check the touch location and touch type. If it is determined that the touch event is a function execution touch event, the control unit 170 executes the function corresponding to the touch event.

The control unit 170 is also capable of discriminating between the selection event for selecting at least one touch region or a touch movement event for moving the touch across the touch regions. For example, if it is determined that the touch event is a selection event such as split-tap, the control unit executes the function corresponding to the selection event. That is, in case that the user makes a gesture in which the touch object drops and touch repeatedly at a touch region while the three finger touch is maintained, the control unit 170 regards this gesture as the split-tap event and executes the functions mapped to the touch region. If the received event is determined as the touch movement event such as upward drag, the control unit 170 executes the function corresponding to the touch movement event. For example, if the user moves the touch object upward while maintaining the three finger touch. At this time, the control unit 170 determines that the drag-up event is detected and thus executes the function corresponding to the drag-up event. The control unit 170 is also capable of executing another function according to the change of the drag direction. For example, the control unit 170 is capable of executing the first function while the drag is made in a first direction and then a second function as the drag direction is changed to a second direction.

After executing the function corresponding to the function execution touch event, the procedure proceeds to step 350. The control unit 170 determines whether the three finger touch is released at step 350. If it is determined that the three finger touch is not dropped, the control unit 170 returns to step 340. If it is determined that the three finger touch is released, the procedure goes to step 360.

The control unit 170 deactivates the functions mapped to the respective touch regions at step 360. Here, the control unit 170 is capable of removing at least one function key from the application execution screen.

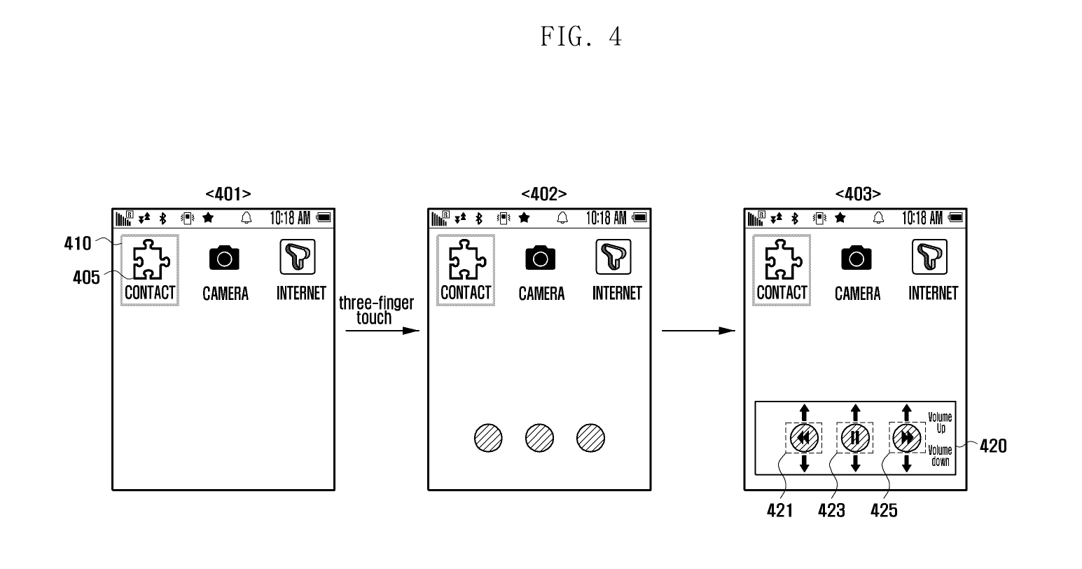

FIGS. 4 to 6 are diagrams illustrating exemplary Text-To-Speech (TTS) application execution screens providing control functions according to an embodiment of the present invention. In particular, FIG. 4 shows exemplary TTS application execution screens with the activated functions mapped to the respective touch regions in detection of the three finger touch.

Referring to FIG. 4, if the three finger touch event is detected during execution of the TTS application, the control unit 170 controls such that the screens 401 to 403 are displayed in sequence during these operations.

That is, as shown in the screen image 401, while the TTS application is running, the control unit 170 is capable of controlling the display panel 143 to display the execution screen as denoted by reference number 401. The execution screen 401 shows the state in which the TTS application is executed on the home screen. The control unit 170 can control such that the pointer focus 410 is placed at an icon 405 on the home screen to execute the TTS application. At this time, the control unit 170 is capable of controlling the audio processing unit 130 to output an audio output of the name of the application represented by the icon 405 at which the pointer cursor is placed. Here, the control unit 170 is capable of executing the function corresponding to an object to which the pointer focus 405 is moved according to the user manipulation.

Then, as shown in the screen image 402, while the TTS application is running as shown in the execution screen 401, if the three finger touch is detected as shown in the screen 402, the control unit 170 detects the three finger touch event and then in response, controls the display so that the functions mapped to the respective touch regions are activated as shown in the screen 403. Here, the control unit 170 can control such that the functions mapped to the touch regions 421, 423, and 425, e.g. speech method and related functions, are presented. The control unit 170 is capable of controlling the display panel 143 to display a controller 420 including function keys. For example, the control unit 170 is capable of controlling the display panel 143 to display the function keys corresponding to the touch regions 421, 423, and 425. The controller 420 also can be displayed along with the notification text about the executable functions.

Thereafter, as shown in the screen image 403, the controller 420 includes the function keys such as ‘play previous speech’ function key associated with the selection of the touch region 421, ‘pause’ function key associated with the selection of the touch region 423, and ‘play next speech’ function key associated with the selection of the touch region 425. For guiding h the touch movement gesture at the touch regions 421, 423, and 425, the controller 420 presents the symbols and/or texts indicating ‘volume-up’ function corresponding to the upward movement and ‘volume-down’ function corresponding to the downward movement.

In addition to the functions depicted in the screen 403, it is possible to configure such that other TTS application-related functions can be executed. The controller 420 presenting the functions mapped to the entire touch regions can be configured such that the indicators are displayed at the touch regions 421, 423, and 425 for a predetermined time.

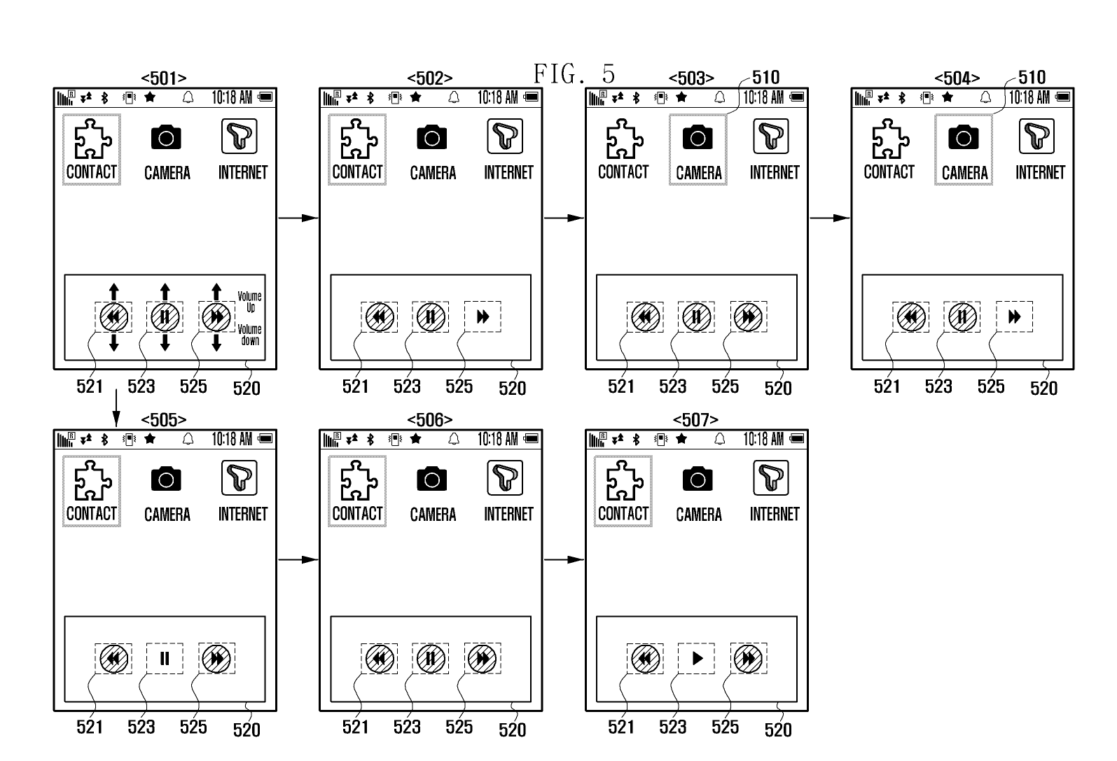

FIG. 5 shows exemplary execution screens having functions executed in response to the split-tap event made at one of the touch regions corresponding to the three finger touch.

Referring to FIG. 5, the control unit 170 controls the display such that the execution screens 501 to 507 are displayed with the execution of the function associated with the corresponding regions according to the split-tap gesture.

As shown in the screen image 501, when the three finger touch is detected during the execution of the TTS application, the control unit 170 controls the display panel 143 to display the controller 520 corresponding to the touch regions 521, 523, and 525. Thereafter, the control unit 170 controls such that the corresponding function is executed according to the touch gesture associated with at least one touch region.

For example, if a tap event, i.e. split-tap event, is detected at the touch region 525 while the user maintains the touch at the touch regions 521 and 523 as shown in the execution screens 502 to 504, the control unit 170 executes the function according to the selection of the touch region 525. That is, the control unit 170 controls to execute the function corresponding to the ‘play next speech’ function key selected by the split-tap. At this time, the control unit 170 controls the display panel 143 to move the pointer focus 510 to the next icon and controls the audio processing unit 130 to output an audio signal related to the camera icon at which the focus is placed. That is, when the input as split-tap at button 525 is detected, the pointer moves “next” icon and outputs the audio signal related to the next icon at which focus is placed. Therefore the “play next speech” function moves the pointer to the next icon and output the audio signal by split-tapping the button 525.

Also, if the drop and touch events are detected in sequence at the touch region 525 in the state that the three finger touch is maintained as shown in the screen 503, the control unit 170 is capable of performing another function corresponding to the events. For example, if the user makes a drop (or lift) and maintains the touch over predetermined time at the touch region 525, the control unit 170 is capable of controlling to perform a ‘quick move to next object to listen’ function according to the selection of the touch region 525. The split-tap at the button 525 actuates the “play next speech” whereas the action of drop and maintaining touch at the button 525 during multi-touch actuates “quick move next object to listen, which automatically move the pointer to the next icon and automatically output the audio signal at which focus is placed during the maintaining touch.

If a function execution touch event is detected at one of the touch regions, the control unit 170 is capable of controlling the display panel 143 to output the function key associated with a specific type of the function execution touch event. For example, the control unit 170 is capable of controlling the display panel 143 to display the function key or function information related to the speech type play related to the selection event immediately after detecting the split-tap event as shown in the screens of FIG. 5.

Alternatively, as shown in the screen image 505, if it is determined that the split-tap event is detected at the touch region 523 from the screen image 501, the control unit 170 is capable of executing a ‘pause’ function according to the selection of the touch region 523 as shown in the screens 505 to 507. More specifically, if the drop(or lift), touch, and drop (or lift) events are detected in sequence at the touch region 523 while the three finger touch is maintained as shown in the screen 505 to 507, the control unit 170 is capable of executing ‘play’ function according to the reselection of the touch region 523. Here, the audio content of “contact” is played because TTS mode is being operated.

In this manner, the control unit 170 is capable of performing different functions alternatively according to the number of selections of a specific touch region. The method of the present invention displays the speech playback-related function keys at the touch regions 521, 523, and 525 such that the user is capable of accessing the functions related to the TTS application on its execution screen quickly, thus resulting in improvement of convenience. While play mode is executed, the controller disappears and the play mode is continued when all three fingers are removed. That is, while another mode is executed, such another mode is continued whereas the controller is removed.

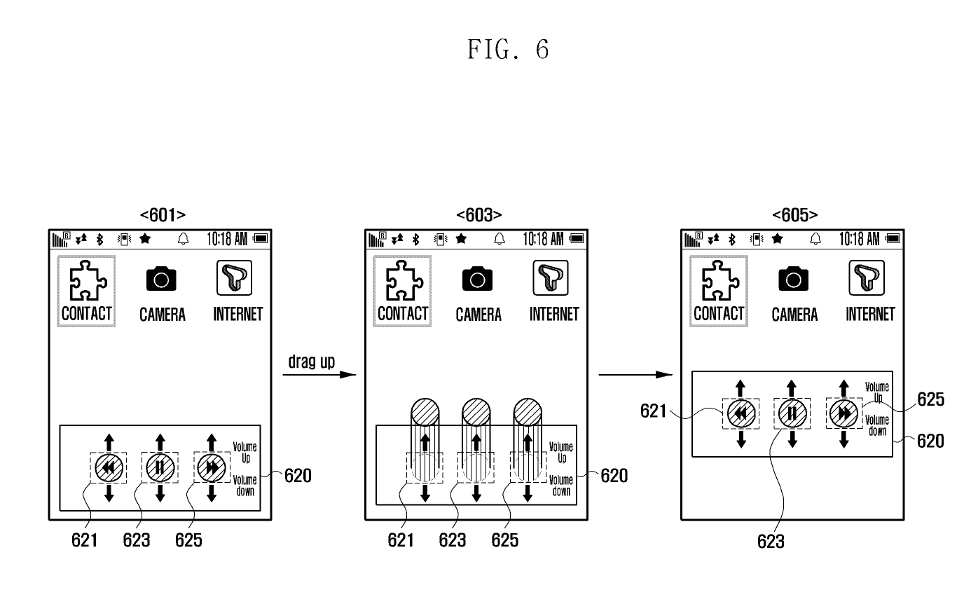

FIG. 6 shows exemplary execution screens of a function executed according to the drag-up event made at one of the touch regions corresponding to the three finger touch.

Referring to FIG. 6, after the detection of the three finger touch as shown in the image screen 601, the control unit 170 controls such that the execution screens 601 to 605 are displayed in execution of the function related to the touch regions according to the drag-up gestured.

More specifically, the control unit 170 controls the display panel 143 to display the controller 620 around the touch regions 621, 623, and 625 as shown in the screen 603. Then, the control unit 170 controls such that the corresponding functions are executed according to the touch gesture related to all touch regions.

For example, if a touch movement event for moving the touch regions 621, 623, and 625 in a specific direction as shown in the screen 603, the control unit 170 controls such that the ‘volume-up’ function is executed according to the movement direction of the drag-up gesture. At this time, the control unit 170 is capable of controlling the audio processing unit 130 to increase the volume as much as the value corresponding to the movement distance of the drag-up gesture.

In addition, if it is determined that the upward drag has occurred at the three touch regions 621, 623, and 625 as shown in the screen 603, the control unit 170 is capable of controlling the display panel 143 to display only the information on the volume control function as the function related to the touch movement event.

If the three touch regions 621, 623, and 625 are maintained for a predetermined time duration after the occurrence of the drag-up event, the control unit 170 is capable of controlling the display panel 143 to display the controller 620 around the touch regions 621, 623, and 625 again at a higher level as shown in the screen 605.

Thereafter, if the drop event is detected at all of the touch regions 621, 623, and 625 after the occurrence of the drag-up event, the control unit 170 controls such that the controller 620 disappears and the functions mapped to the touch regions 621, 623, and 625 are deactivated.

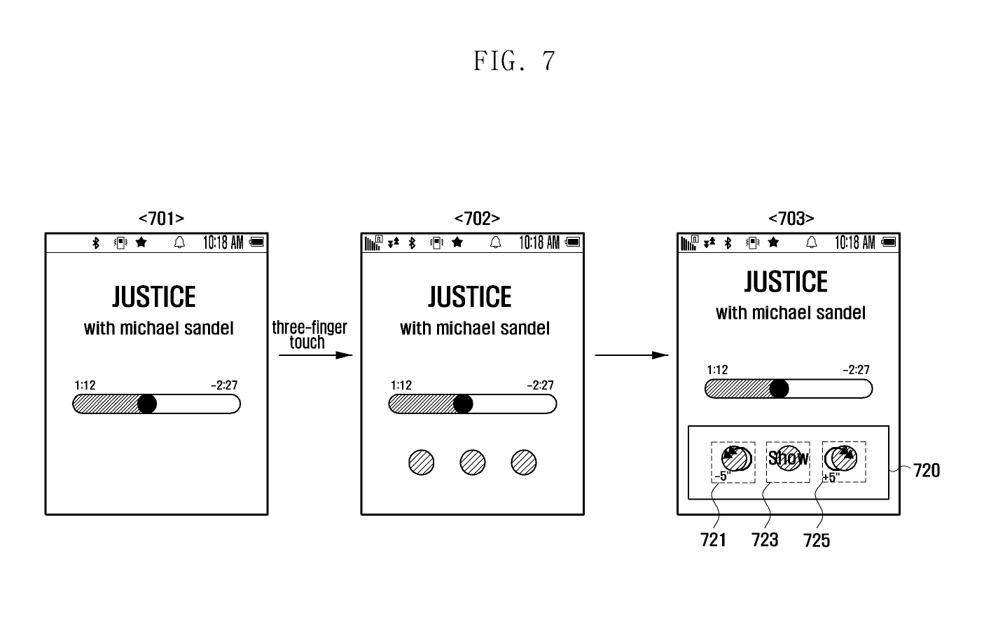

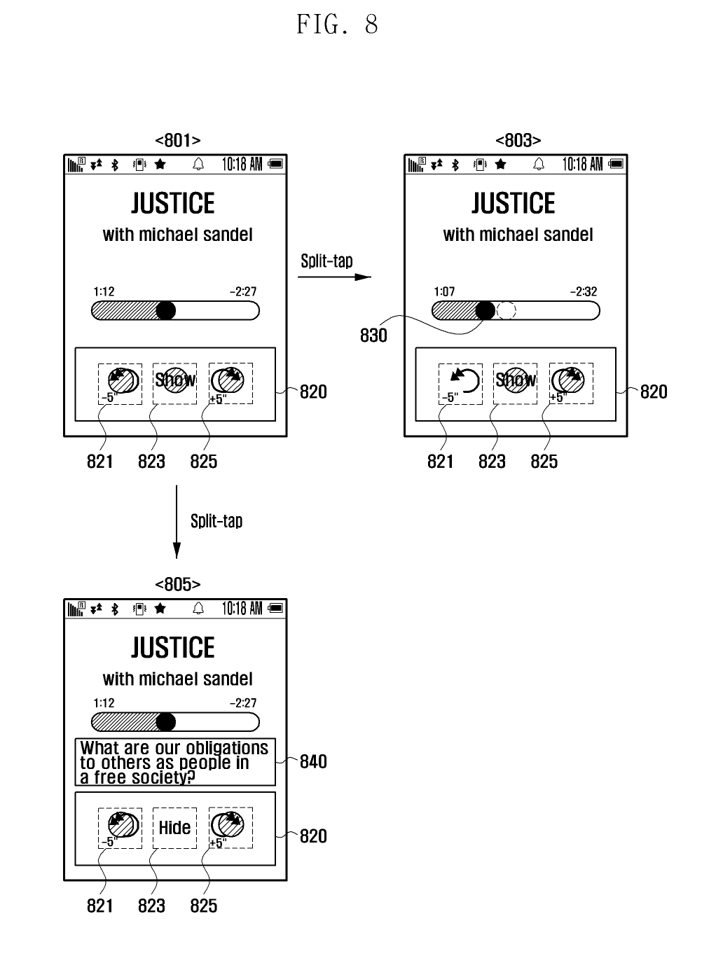

FIGS. 7 and 8 are diagrams illustrating exemplary audio playback application execution screens providing control functions according to another embodiment of the present invention.

In particular, FIG. 7 shows exemplary execution screens with the functions mapped to the respective touch regions when the three finger touch is detected in execution of the audio playback application.

As shown, the control unit 170 controls the display panel 143 to display the audio book playback screen in accordance with the execution of the audio playback application. If the three finger touch event is detected in the state where the audio playback applications is running as shown in the screen 702, the control unit 170 controls the display panel 143 to display the controller 720 related to the audio playback as shown in the screen 703. At this time, the control unit 170 can control such that the controller 720 is configured with the function keys corresponding to the functions mapped to the touch regions 721, 723, and 725. In more detail, the control unit 170 can control such that ‘play 5 seconds before’ function key, ‘show/hide text’ function key, and ‘play 5 seconds after’ function key are present onto the respective touch regions 721, 723, and 725.

FIG. 8 shows exemplary execution screens with the functions executed according to the split-tap event detected at one of the touch regions of the three finger touch.

Referring to FIG. 8, the control unit 170 controls such that the screens 801 to 805 are displayed in the process of executing the functions mapped to the touch regions according to the split-tap gesture after the detection of the three finger touch on the audio book playback screen.

For example, if the ‘play 5 seconds before’ function key is selected according to the split-tap event at the touch region 821 as shown in the screen 803, the control unit 170 can control the audio playback application to execute the corresponding function. Here, the control unit 170 controls the audio processing unit to play the audio back at 5 seconds before the current time and controls the display panel 143 to display the playback indicator 830 as it were at 5 seconds before.

If it is determined that the ‘text display’ function key is selected by the split-tap event at the touch region 823 as shown in the screen 805, the control unit 170 can control the audio playback application to execute the corresponding function. The “split-tap” is defined as a series of action consisting of the drop, touch, and drop during the multi touch state. In the embodiment, the last drop action distinguishes the “split-action” from another series of action consisting of the drop and maintaining touch for executing “quick move to next object to listen”.

For example, if the split-tap event is detected at the touch region 823, the control unit 170 can control the display panel 143 to present the text box 840 having the text being played currently on the playback screen. The control unit 170 also can control such that the ‘hide text’ function key appears instead of the ‘show text’ function key after the detection of the split-tap event as shown at the touch region 823 of the screen 805. If the split-tap event is detected again at the touch region 823, the control unit 170 can control the audio playback application to execute the ‘hide text’ function.

As described above, the touchscreen-enabled terminal and application control method thereof according to the present invention controls, when the three finger touch is detected in execution of an application, the display panel 143 to display at least one function key on the execution screen and thus activate the functions mapped to the respective touch regions. The terminal 100 controls the application with the functions mapped to the respective touch regions according to the function execution touch event. The touchscreen-enabled terminal and application control method thereof according to the present invention is capable of facilitating user's manipulation of specific functions of the application.

As described above, the touchscreen-enabled terminal and application control method thereof according to the present invention activates specific functions of the application with the presentation of the corresponding function keys at the touch regions formed with a multi-touch, e.g. three finger touch, thereby facilitating user's manipulation of the functions.

Also, the touchscreen-enabled terminal and application control method thereof according to the present invention activates application control functions anywhere the three finger touch is detected on the touch screen, whereby the user can control the application with the least action especially when the touchscreen is large in size.

The touchscreen-enabled terminal and application control method thereof according to the present invention is advantageous to control the application using the touchscreen.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove with specific terminology, this is for the purpose of describing particular embodiments only and not intended to be limiting of the invention. While particular embodiments of the present invention have been illustrated and described, it would be obvious to those skilled in the art that various other changes and modifications can be made without departing from the spirit and scope of the invention.

What is claimed is:

1. An application control method comprising:
executing an application;
displaying an execution screen of the application; and
presenting, when a multi-touch event with at least three touch regions is detected, at least one function key mapped to the respective touch regions.

2. The application control method of claim 1, wherein presenting comprises presenting the at least one function key at a respective one of the touch regions.

3. The application control method of claim 1, further comprising:
detecting a function execution touch event in at least one of the touch regions; and
performing a function related to the function execution touch event.

4. The application control method of claim 3, wherein detecting comprises:
detecting a selection event for selecting at least one of the touch regions; and
detecting a touch movement event for moving at least one of the touch regions.

5. The application control method of claim 4, wherein detecting a selection event comprises one of:
determining, when a drop is detected at a specific touch region after the multi-touch event, occurrence of the selection event for selecting the touch region;
determining, when a drop and a retouch are detected in sequence at a specific touch region after the multi-touch event, occurrence of the selection event for selecting the touch region; and
determining, when a drop and a tap are detected in sequence at a specific touch region after the multi-touch event, occurrence of the selection event for selecting the touch region.

6. The application control method of claim 5, wherein performing comprises carrying out the function related to the selection of the touch region.

7. The application control method of claim 6, wherein the application is a Text-To-Speech application and the related function is a speech method control function.

8. The application control method of claim 4, wherein detecting a touch movement event comprises detecting a drag event for moving the touch in at least one direction after the multi-touch event.

9. The application control method of claim 8, wherein performing the function comprises carrying out a function according to the direction.

10. The application control method of claim 9, wherein the function is a volume up/down function.

11. The application control method of claim 1, further comprising removing, when the drop is detected in at least one of the three touch regions of the multi-touch event, the at least one function key on the screen.

12. An application control apparatus comprising:
a touchscreen including a display panel for displaying an application execution screen of an application and a touch panel for receiving an input for controlling the application; and
a control unit which controls, when a multi-touch event with at least three touch regions is detected, the touchscreen to display one or more function keys mapped to the at least three touch regions.

13. The application control apparatus of claim 12, wherein the control unit controls the touchscreen to display each of the one or more function keys at a respective touch region.

14. The application control apparatus of claim 12, wherein the control unit controls, when a function execution touch event is detected in at least one touch region on the touch screen, to perform a function related to the function execution touch event.

15. The application control apparatus of claim 12, wherein the function execution touch event is one of a selection event for selecting at least one of the touch regions and a touch movement event for moving at least one of the touch regions.

16. The application control apparatus of claim 15, wherein the selection event is one of: a drop detected at a specific touch region after the multi-touch event, a drop and a retouch detected in sequence at a specific touch region after the multi-touch event, occurrence of the selection event for selecting the touch region, and a drop and a tap detected in sequence after the multi-touch event.

17. The application control apparatus of claim 15, wherein the touch movement event is a drag event for moving the touch in at least one direction after the multi-touch event.

18. The application control apparatus of claim 17, wherein the control unit controls to execute different functions according to the direction of the touch movement event.

19. The application control apparatus of claim 13, wherein the application is a Text-To-Speech application and the related function is a speech method control function.

20. The application control apparatus of claim 12, wherein the control unit removes, when the drop is detected in at least one of the three touch regions of the multi-touch event, the one or more function keys on the screen.
